(19) United States
(12) Patent Application Publication
(10) Pub. No.: US 2010/0053945 A1
(43) Pub. Date: Mar. 4, 2010

(54) LUMINAIRE FOR INSPECTING THE SURFACE QUALITY OF AN OBJECT

(75) Inventor: Petrus Adrianus Josephus Holten, Winterswijk (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/514,112

(22) PCT Filed: Nov. 8, 2007
(86) PCT No.: PCT/IB07/54532

§ 371 Date: May 8, 2009

(30) Foreign Application Priority Data
Nov. 13, 2006 (EP) 06123964.6

(51) Int. Cl. F21V 7/00

(52) U.S. Cl. 362/217.07

(57) ABSTRACT

A luminaire comprising a reflector (4) for reflecting the appearance of a cylindrically shaped elongated light source (3), wherein the reflecting surface (5) of the reflector (4) extends symmetrically at both sides of a median plane (7) and parallel to the axis (6,26) of the light source (3), and wherein the appearance of the elongated light source (3) is visible at the front side of the luminaire directly as well as through said reflecting surface (5). The appearance of the light source (3) is visible as three parallel bright stripes in two areas at both side of the median plane (7)

### FIELD OF THE INVENTION

The invention relates to a luminaire comprising a reflector for reflecting the appearance of a cylindrically shaped elongated light source, wherein the reflecting surface of the reflector extends symmetrically at both sides of a median plane through the axis of the elongated light source and parallel to said axis, and wherein the appearance of the elongated light source is visible at the front side of the luminaire directly as well as through said reflecting surface.

### BACKGROUND OF THE INVENTION

Such a luminaire is disclosed in JP3169098 and can be installed, for example, along an automobile assembly line in order to inspect the surface quality and alignment of body parts of the automobile during the assembly operation. The cylindrically shaped elongated light source, such as a TL-lamp, is visible several times in a certain area in front of the luminaire. When the luminaire is viewed from that area, the light source appears as a number of parallel straight stripes of bright light, with relatively dark regions being present between the straight stripes. The surface of the body parts of the automobile reflects the stripes, and the reflection can be seen by the human eye. Particularly when the automobile moves with respect to the luminaire and/or the location of observation by the human eye, surface smoothness deviations or misalignments of body parts of the automobile can be seen.

In the luminaire described in JP3169098, a substantial portion of the reflector near and behind the light source is made non-reflective in order to improve contrast between the appearance of the light source and the adjacent reflector parts when the luminaire is observed from a location in front of the luminaire. However, absorption of a substantial portion of the light radiation results in a substantial reduction of the illumination intensity. Consequently, such a non-reflective portion near and behind the light source should be avoided when the luminaire is also used for illuminating the area in front of it.

Three bright stripes are sufficient for performing an appropriate inspection, but there may be more than three bright stripes. Furthermore, it is an advantage when bright stripes are visible at any location in a relatively large area in front of the luminaire. The luminaire may also provide illumination of the automobile assembly line or any other operation to be inspected, in which a relatively large area should be illuminated, i.e. much larger than the area where the bright stripes are visible.

### OBJECT AND SUMMARY OF THE INVENTION

It is an object of the invention to provide a luminaire, wherein the appearance of the elongated light source is visible at the front side of the luminaire directly as well as through reflection, so that at least three bright stripes are visible in a certain area in front of the luminaire, and wherein said certain area is relatively large.

It is a further object of the invention to provide a luminaire, wherein the appearance of the elongated light source is visible at the front side of the luminaire directly as well as through reflection, so that at least three bright stripes are visible in a certain area in front of the luminaire, and wherein said certain area is located at a distance from the median plane of the luminaire.

It is another object of the invention to provide a luminaire, wherein the appearance of the elongated light source is visible at the front side of the luminaire directly as well as through reflection, so that at least three bright stripes are visible in a certain area in front of the luminaire, and wherein said luminaire also illuminates a relatively large further area in front of the luminaire.

It is yet another object of the invention to provide a luminaire, wherein the appearance of the elongated light source is visible at the front side of the luminaire directly as well as through reflection, so that at least three bright stripes are visible in a certain area in front of the luminaire, and wherein the reflecting surface of the reflector extends behind as well as at both sides of the light source.

In order to achieve one or more of these objects, the shape of the reflecting surface has a substantially cylindrically curved concave central portion, partly located behind the elongated light source, while each edge of said central portion is connected with a substantially flat first portion of the reflecting surface, which first portions extend substantially perpendicularly to said median plane, the outer edge of each first portion being connected with a substantially flat second portion of the reflecting surface, which second portions extend at a first angle to said median plane, the outer edge of each second portion being connected with a substantially flat third portion of the reflecting surface, which third portions extend at a second angle to said median plane, which second angle is larger than said first angle, the outer edge of each third portion being connected with a substantially flat fourth portion of the reflecting surface, which fourth portions extend at a third angle to said median plane, which third angle is smaller than said first angle, so that said second portion and said fourth portion of the reflecting surface at one side of the median plane reflect the appearance of the elongated light source to an area at the other side of the median plane, in which area the appearance of said elongated light source is visible as three parallel bright stripes. Said second angle is preferably between 80° and 100° and/or said first angle is smaller than 20° and said third angle is smaller than 35°.

The expression ‘substantially flat surface’ is understood to mean that the surface is flat or curved with a relatively large radius. The angle at which the surface extends to the median plane is the average angle, in case the surface is curved.

Two areas where bright stripes are visible are in front of the luminaire, i.e. one area at each side of the median plane. These areas are located at a substantial distance from the median plane of the luminaire. The two areas where the bright stripes are visible are relatively large, so that they cover a large region of inspection. The luminaire illuminates the region between these two areas in a normal way, while the appearance of the light source is not visible in front of the luminaire in a regular and equidistant pattern of bright stripes.

Because of the substantially concave shape of the central portion of the reflecting surface, i.e. the portion near the light source, the reflection of light radiation by this portion is directed in such a way that it does not affect the appearance of the light source, so that the edges of the directly visible light source are in clear contrast with the darker areas that surround the bright stripe.

The reflecting surface may of course have more substantially flat portions, so that more than three stripes are visible in an area in front of the luminaire.

In a preferred embodiment, the substantially flat second portions and/or fourth portions of the reflecting surface have concavely curved shapes, in particular a curve with a large radius, so that the surface deviates only slightly from a completely flat shape. Such a shape increases the distribution of light radiation from the luminaire and improves its illuminating effect. The width of the relevant bright stripe seen in front of the luminaire is slightly enlarged. It has been found that such an enlargement is not a real disadvantage and is compensated by the fact that, because of the reflection, the distance to the relevant appearance of the light source is slightly larger.

In a preferred embodiment, the reflecting surface has a central portion which is substantially coaxial around a central axis, which central axis is located preferably midway between the axis of the elongated light source and its front side, i.e. at a distance of a quarter of the diameter of the cylindrical light source from the axis of said light source. A substantial portion of the light radiation reflected by said central portion of the reflecting surface is thus re-directed by the light source to the area to be illuminated in front of the luminaire.

The plane of the two first portions of the reflecting surface intersects the median plane perpendicularly at a location near the rear side of the light source, preferably between said rear side and the axis of the elongated light source. These two portions thus reflect the light radiation of the light source to the area in front of the luminaire, which thus provides an appropriate illuminating effect.

### BRIEF DESCRIPTION OF THE DRAWINGS

The invention will now be elucidated by means of a description of an embodiment of the luminaire comprising a reflector for reflecting the appearance of a cylindrically shaped elongated light source, and with reference to the drawings, in which:

FIG. 1 is a perspective view of the luminaire;

FIG. 2 is a cross-sectional view of the luminaire;

FIG. 3 is a cross-sectional view of the reflector of the luminaire; and

FIGS. 4A, 4B, 4C and 4D represent bright stripes produced by the luminaire.

### DESCRIPTION OF EMBODIMENTS

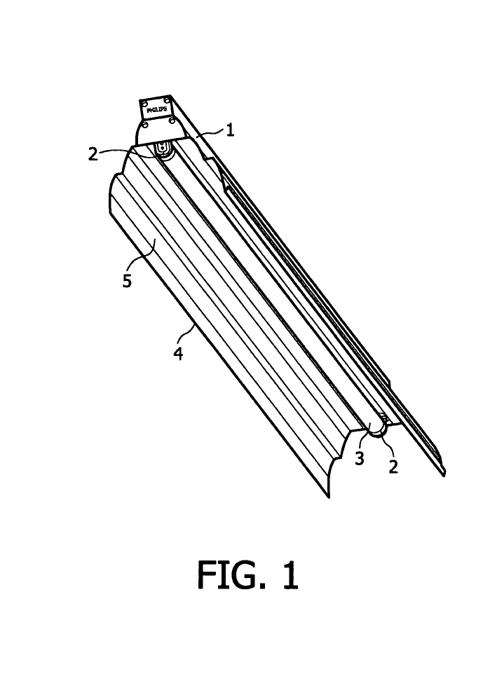

FIG. 1 is a perspective view of the complete luminaire, comprising a base part 1 that can be fixed to a wall or a ceiling or the like. The base part I is provided with means 2 for holding the straight tubular lamp 3, which means 2 are present at both ends of the luminaire. Furthermore, a reflector 4 is attached to the base part 1, which reflector 4 has a reflecting inner surface 5. The whole inner surface 5 of the reflector extends parallel to the longitudinal axis of the lamp 3.

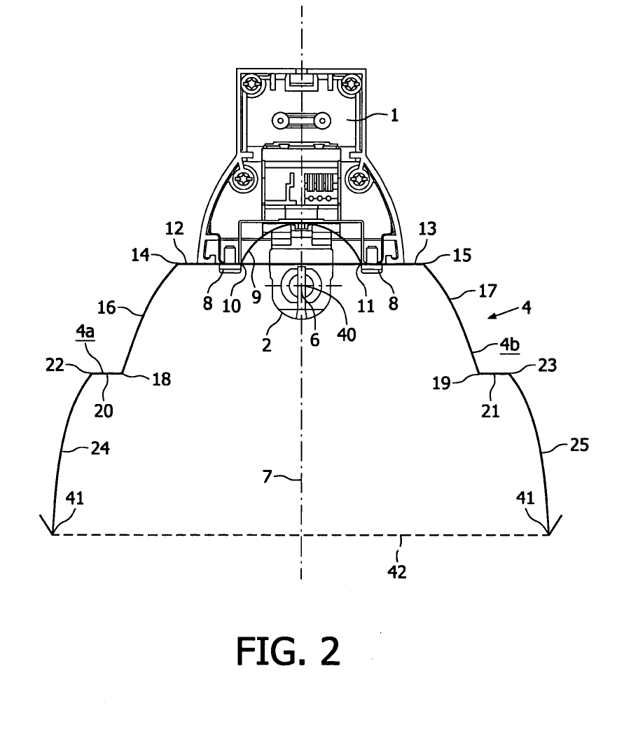

FIG. 2 is a sectional view of the luminaire perpendicular to the longitudinal axis 6 of the lamp 3 (not shown in FIG. 2). The base part I accommodates means for supplying electric power to the lamp 3. The base part I and the reflector 4 have a shape which is symmetrical with respect to a median plane 7 of the luminaire.

The reflector 4 is attached to the base part I by means of screws 8. The reflector 4 has a cylindrically curved central portion 9, which is partly located behind the lamp 3. Each edge 10,11 of central portion 9 is connected with a flat first portion 12,13 of the reflector 4, which first portions 12,13 extend perpendicularly to the median plane 7. The outer edge 14,15 of each first portion 12,13 is connected with a curved second portion 16,17 of the reflector 4. The two second portions 16,17 are curved with a relatively large radius, so that these portions 16,17 of the reflector 4 can be regarded as being substantially flat. The outer edge 18,19 of each second portion 16,17 of the reflector 4 is connected with a flat third portion 20,21 of the reflector 4 extending perpendicularly to the median plane 7. The outer edge 22,23 of each third portion 20,21 is connected with a curved fourth portion 24,25 of the reflector 4.

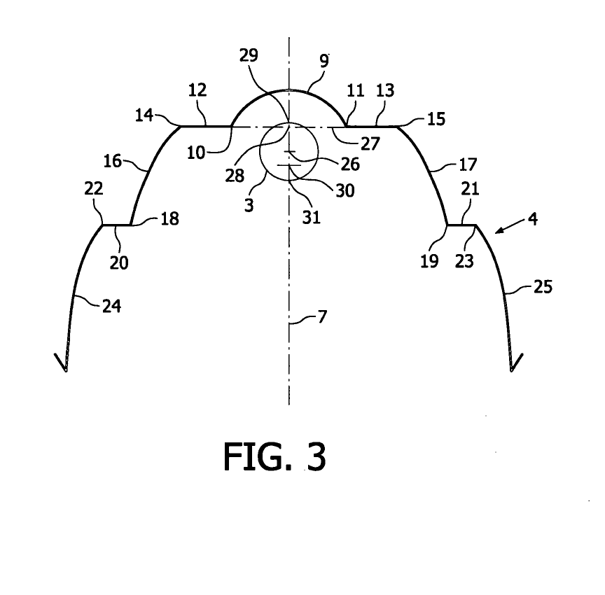

FIG. 3 is a sectional view of the reflector 4, showing the position of the lamp 3 with respect to the reflector 4. The longitudinal axis 26 of the lamp 3 is located in front of the plane 27 of the flat portions 12,13 of the reflector 4, which plane 27 intersects the median plane 7 at a location denoted by reference numeral 28, i.e. between the rear side 29 of the lamp 3 and the axis 26 of the lamp 3. As the main portion of lamp 3 is located in front of the plane 27, the first flat portions 12,13 of the reflector 4 will reflect a substantial portion of the light radiation of the lamp 3 to the area in front of the luminaire.

The central portion 9 of the reflector 4 is cylindrically curved around a central axis 30 midway between axis 26 of the lamp 3 and the front side 31 of the lamp 3.

The reflecting surface 5 of the reflector 4 provides illumination of an area in front of the luminaire, which area extends at both sides of the median plane 7. Additionally, the curved portions 16,17,24,25 reflect the appearance of the lamp 3 towards certain areas in front of the luminaire. The curved portions 16,24 at the left side (in FIG. 3) of the median plane 7 reflect the appearance of the lamp 3 to an area in front of the luminaire at the right side of the median plane 7, and the curved portions 17,25 at the right side of the median plane 7 reflect the appearance of the lamp 3 to an area in front of the luminaire at the left side of the median plane 7.

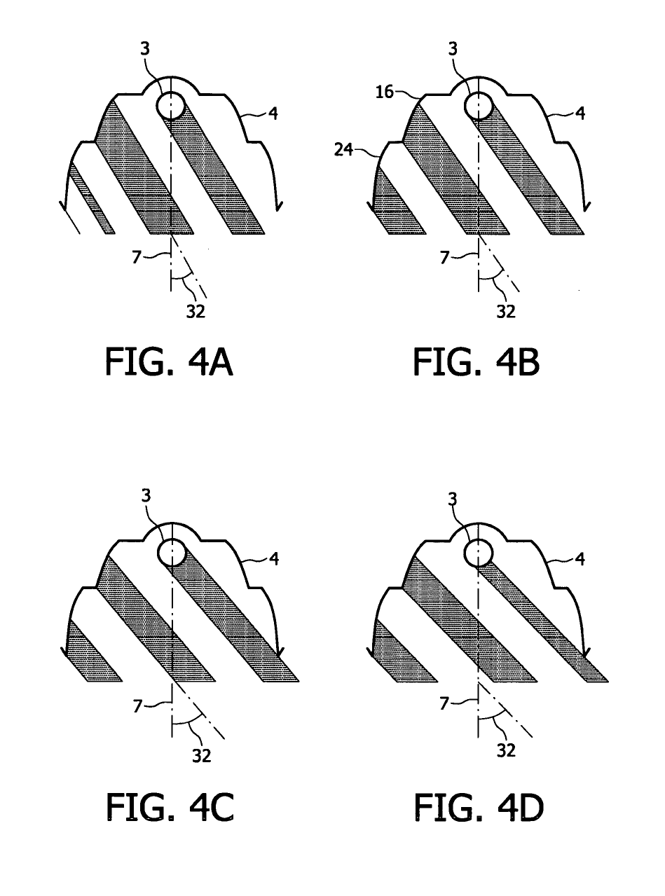

The reflections of the appearance of the lamp 3 are diagrammatically shown in FIGS. 4A, 4B, 4C and 4D. Each Figure shows the reflection as viewed from a different position at the right side of the median plane 7. The viewing angle 32 to the median plane 7 corresponds to said position. The dark stripes in the Figures represent the bright stripes that are seen in front of the luminaire at a certain position within the area where the bright stripes are visible, i.e. viewing at the indicated angle 32 to the median plane 7. One of the bright stripes is the appearance of the lamp 3 without any reflection and the other two bright stripes are appearances that are reflected by the reflector 4.

The angle between the average direction of the fourth portion 24 (see FIG. 4B) of the reflector 4 and the direction of the median plane 7 is smaller than the average direction of the second portion 16 of the reflector 4 and the direction of the median plane 7. Consequently, the directions in which the curved portions 16,24 reflect the appearance of the lamp 3 are similar (angle 32).

The luminaire described above provides appropriate illumination of a certain area in front of the luminaire, as well as reflections of the appearance of the straight tubular lamp towards certain areas at both sides of the median plane 7, which areas are located at a substantial distance from the median plane 7.

The embodiment of the luminaire described above is only an example of a luminaire according to the invention; many other embodiments are possible.

In general terms and with reference to FIGS. 1 and 2, the luminaire according to the invention can be described as follows.

A luminaire comprising contacting means 2 for holding an elongated electric light source, said contacting means defining a reflector axis 40, in FIG. 1 coinciding with a longitudinal lamp axis 6. The luminaire further comprises a (concave) elongated reflector 4 with a reflector edge 41 bordering a light emission window 42, and a reflecting surface 5 for reflecting light from the elongated light source to form at least one reflection image thereof. The reflecting surface has two (integral) halves 4a,4b which extend parallel to said reflector axis and extend as mirror parts at both sides of a median plane 7 through said reflector axis. The light source as well as the at least one reflection image are visible through the light emission window.

Each half of the reflecting surface has a substantially cylindrically curved concave central portion 9, alternating substantially flat portions 12,13,20,21 and portions 16,17,24,25, adjacent portions of which are connected via a respective edge 14,15,18,19,22,23. All portions extend along the reflector axis.

The central portion is (at least partly) located at a side of the elongated light source facing away from the light emission window and is connected to a first portion 12,13 via an edge 10,11, respectively.

Each portion denoted by an odd reference numeral extends at a respective comparatively large angle to the median plane, and each portion denoted by an even reference numeral extends at a respective comparatively small angle to the median plane, which small angle is smaller than said large angle, the small angle of the n+2^{nd} even portion being smaller than the respective small angle of the nth even portion, n being 2, 4 or 6.

Upon reflection of light from the light source at one side of the median plane, the portions denoted by even reference numerals create a respective reflection image at the other side of the median plane for the light source to be visible as a plurality of parallel bright stripes.

### LIST OF REFERENCE NUMERALS

1. base part of luminaire
2. means for holding the lamp
3. lamp
4. reflector
5. inner surface of reflector 4
6. longitudinal axis of lamp 3
7. median plane of the luminaire
8. screws
9. central portion of the reflector 4
10. edge of central portion 9
11. edge of central portion 9
12. flat portion of reflector 4
13. flat portion of reflector 4
14. edge of portion 12
15. edge of portion 13
16. curved portion of reflector 4
17. curved portion of reflector 4
18. edge of portion 16
19. edge of portion 17
20. flat portion of reflector 4
21. flat portion of reflector 4
22. edge of portion 20
23. edge of portion 21
24. curved portion of reflector 4
25. curved portion of reflector 4
26. axis of lamp 3
27. plane of portions 12 and 13
28. location where plane 27 intersects median plane 7
29. rear side of lamp 3
30. axis of cylindrical shape of portion 9 of reflector 4
31. front side of lamp 3
32. angle between median plane 7 and viewing direction
40. contacting means
41. reflector edge
42. light emission window
4a, 4b reflector halves

1. A luminaire comprising a reflector for reflecting the appearance of a cylindrically shaped elongated light source, wherein
the reflecting surface of the reflector extends symmetrically at both sides of a median plane through the axis of the elongated light source and parallel to said axis,
the appearance of the elongated light source is visible at the front side of the luminaire directly and through said reflecting surface, and
the shape of the reflecting surface has a substantially cylindrically curved concave central portion, partly located behind the elongated light source, each edge of said central portion being connected with a substantially flat first portion of the reflecting surface, wherein
first portions extend substantially perpendicularly to said median plane, the outer edge of each first portion being connected with a substantially flat second portion of the reflecting surface,
second portions extend at a first angle to said median plane, the outer edge of each second portion being connected with a substantially flat third portion of the reflecting surface,
third portions extend at a second angle to said median plane, the second angle being larger than said first angle, the outer edge of each third portion being connected with a substantially flat fourth portion of the reflecting surface, and
fourth portions extend at a third angle to said median plane, the third angle being smaller than said first angle, so that said second portion and said fourth portion of the reflecting surface at one side of the median plane reflect the appearance of the elongated light source to an area at the other side of the median plane, in which area the appearance of said elongated light source is visible as three parallel bright stripes.

2. A luminaire as claimed in claim 1, wherein the second angle is between 80° and 100°.

3. A luminaire as claimed in claim 1, wherein the first angle is smaller than 20°.

4. A luminaire as claimed in claim 1, wherein the third angle is smaller than 35°.

5. A luminaire as claimed in claim 1, wherein the second portion of the reflecting surface has a concave shape.

6. A luminaire as claimed in claim 1, wherein the fourth portion of the reflecting surface has a concave shape.

7. A luminaire as claimed in claim 1, wherein the reflecting surface has a central portion which is coaxial around a central axis, which central axis is located preferably midway between the axis of the elongated light source and its front side.

8. A luminaire as claimed in claim 1, wherein the plane of the two first portions of the reflecting surface intersects the median plane perpendicularly at a location near the rear side of the light source, preferably between said rear side and the axis of the elongated light source.
